(19) United States
(12) Patent Application Publication
(10) Pub. No.: US 2025/0182922 A1
(43) Pub. Date: Jun. 5, 2025

(54) STORAGE DEVICE FOR STORING AND/OR TRANSPORTING NUCLEAR FUEL ASSEMBLIES, HAVING A DESIGN WITH IMPROVED MECHANICAL STRENGTH

(71) Applicant: ORANO NUCLEAR PACKAGES AND SERVICES, Montigny-Le-Bretonneux (FR)

(72) Inventors: Olivier DELAGE, LES-CLAYES-SOUS-BOIS (FR); Nicolas BESSIS, MAISONS-LAFFITTE (FR)

(21) Appl. No.: 18/685,947

(22) PCT Filed: Aug. 24, 2022
(86) PCT No.: PCT/FR2022/051604

§ 371 Date: Feb. 23, 2024

(30) Foreign Application Priority Data
Aug. 24, 2021 (FR) FR2108867

(51) Int. Cl. G21F 5/08; G21F 5/012; G21F 5/12

(52) U.S. Cl. CPC G21F 5/08; G21F 5/012; G21F 5/12

(57) ABSTRACT

A storage device for transporting and/or storing nuclear fuel assemblies, comprising transverse structures spaced apart from one another and of which at least one includes a first component as well as a second component attached by a connecting device comprising: a male coupling member borne by the first component, the male member taking the form of a projection; a female coupling member provided on the second component, the female member taking the form of a groove housing the male member and forming therewith a guideway connection the direction of the guideway of which is parallel to or inscribed in the transverse plane wherein the transverse structure lies.

### TECHNICAL FIELD

The present invention pertains to the field of transporting and/or storing nuclear fuel assemblies, preferably spent assemblies within which the fuel has been irradiated.

### PRIOR ART

Such a device, also called a storage “basket” or “rack”, comprises a plurality of adjacent housings capable of receiving a nuclear fuel assembly.

This storage device is intended to be housed in a cavity of a packaging. The packaging, the basket and the fuel assemblies that are placed in the housings of the basket, form a package.

The basket is designed in order to be able to fulfil three essential functions simultaneously, which will be briefly disclosed below.

The first is the function of thermal transfer of the heat released by the fuel assemblies. Generally, aluminium or one of its alloys is used, due to its good thermal conduction properties.

The second function relates to neutron absorption, and the concern to maintain the subcriticality of the package. This is achieved by using, within the basket, neutron absorber materials known as neutron-absorbing materials, such as boron.

Finally, the third essential function is related to the mechanical strength of the device. It is noted that the overall mechanical strength of the device must be compatible with the regulatory safety requirements for transporting/storing nuclear materials, particularly as regards the so-called “free drop” tests of the package, in various directions.

From the prior art, several ways of forming the basket are known. One of them consists in providing transverse structures, such as wafers, spaced apart from one another by spacers, in the longitudinal direction of the basket. In addition, sleeves, generally of square section and longitudinally oriented, pass through the transverse structures, and each form a housing for receiving a nuclear fuel assembly.

The transverse structures, provided with through-openings for passing the sleeves through, are usually produced from a single component. In the event of regulatory lateral free drop tests having a so-called oblique orientation (for example at 45°), the transverse structures oriented parallel to the dropping direction are subjected to an impact at a peripheral portion in a corner shape, for example forming a V of a 90° angle, the V corresponding to the peripheral corners of the through-openings. This orientation for dropping the package leads to putting significant strain on the V-shaped peripheral portion, with a high risk of deformation leading to the undesired opening of this V. In order to avoid or limit this deformation that is detrimental to the certification of the package, the transverse structures may be reinforced by being oversized, and/or by integrating reinforcing elements.

In any case, this approach for reducing the risks of deformation leads to an increase in the cost and in the mass of transverse structures, which is not desirable.

### DISCLOSURE OF THE INVENTION

Therefore, the aim of the invention is to remedy the drawbacks mentioned above, relating to the embodiments of the prior art.

For this purpose, the object of the invention is a storage device for transporting and/or storing nuclear fuel assemblies, the storage device being intended to be housed in the cavity of a packaging for transporting and/or storing nuclear fuel assemblies, and including adjacent housings, each intended to receive a nuclear fuel assembly.

In addition, the storage device comprises a plurality of transverse structures spaced apart from one another in a longitudinal direction of the storage device using spacing means such as for example spacers placed between the transverse structures, each of these transverse structures being arranged in a transverse plane of the storage device and each comprising a plurality of through-openings for passing the nuclear fuel assemblies through.

According to the invention, at least one of the transverse structures, and preferably a plurality or even all of them, includes a first component as well as a second component attached to one another by a connecting device, the connecting device comprising:
a male coupling member borne by the first component, the male member taking the form of a projection;
a female coupling member provided on the second component, the female member taking the form of a groove housing the male member and forming therewith a guideway connection the direction of the guideway of which is parallel to or inscribed in the transverse plane wherein the transverse structure concerned lies.

Therefore, the invention provides for the production of one or more transverse structures no longer made in one piece, but with at least two distinct components assembled with one another in the manner disclosed above. Thanks to the particular orientation of the guideway connection, in or parallel to the plane of the transverse structure that generally has a relatively low thickness, the cooperation length between the male and female coupling members that form this connection can advantageously be increased.

Advantageously, this results in reinforcing the mechanical strength of the transverse structure in the event of dropping of the package, and this without affecting the mass of the transverse structure.

Moreover, the invention provides at least one of the following optional features, taken alone or in combination.

Preferably, the groove forming the female member has, at one of its two opposite longitudinal ends in the direction of the guideway, a guideway axial abutment cooperating with one of the two opposite longitudinal ends of the projection forming the male member. Thus, in the event of dropping of the package, the mechanical strength of the transverse structure is further reinforced by the bearing between the guideway axial abutment, and the associated longitudinal end of the male member. This bearing can be obtained directly by construction, or by using a small clearance during the dropping.

Preferably, the guideway axial abutment and the associated longitudinal end of the projection have a complementarity of shape ensuring the holding of the longitudinal end of the projection in the groove, in a stacking direction of the male and female coupling members, the stacking direction being orthogonal to the direction of the guideway as well as to the opening plane of the groove. This arrangement leads to a bilateral design of the guideway connection.

In the event of dropping of the package, the mechanical strength of the transverse structure is further reinforced by holding the longitudinal end of the male member in the groove. The shape cooperation can be obtained directly by construction, or by using a small clearance during the dropping.

According to a first possibility, the guideway connection is of unilateral design in a stacking direction of the male and female coupling members, the latter preferably having parallelepiped shapes.

According to a second preferred possibility, the guideway connection is of bilateral design in a stacking direction of the male and female coupling members, the projection and the groove having a complementarity of shape preventing the extraction of the projection outside of the groove via the opening thereof, in the stacking direction of the male and female components.

Thanks to this bilateral design in the stacking direction of the male and female members, in the event of dropping of the packaging, the mechanical strength of the transverse structure is further reinforced by holding the projection in the groove.

Preferably, the projection has two opposite lateral sides having a complementarity of shape with two opposite lateral sides of the groove with which they respectively cooperate, so as to prevent the extraction of the projection outside of the groove via the opening thereof, in the stacking direction of the male and female members.

Preferably, the projection has a section, in a plane orthogonal to the direction of the guideway, in the shape of a dovetail, of a T, or of all or part of a disc.

Preferably, said longitudinal end of the projection, as well as its two opposite lateral sides, have a continuous profile along the entire length of a U-shaped contour of the projection. By way of example, when a dovetail shape is retained, each of the two lateral sides is trimmed so as to show the acute angle required for obtaining such a dovetail shape, and this same acute angle is made at the longitudinal end of the projection in order to ensure a continuity with each of the two lateral sides of the projection, of the same shape.

Advantageously, this results in facilitating the manufacturing for this configuration of guideway connection with reinforced holding of the projection in the groove.

Preferably, the storage device comprises a member for locking the guideway connection, holding the male member relative to the female member in the direction of the guideway, the member for locking the guideway connection preferably being a screw passing through the male and female members. Preferably, the screw(s) make(s) it possible only to hold in position the two components in relation to one another but they are not put under any or very much strain during the impact in the event of dropping, since as a priority the male and female members of the guideway connection take up the impact forces.

Preferably, the first and second components are two peripheral components of the transverse structure, and, preferably, partly delimiting at least one of the through-openings of this transverse structure.

Preferably, the first or the second component has a generally straight beam shape, of which the longitudinal central axis of the beam is parallel to or coinciding with the direction of the guideway.

Preferably, said transverse structure includes a third component arranged so that the second component is located between the first and third components that it connects using another connecting device, this other connecting device comprising:
a male coupling member borne by the third component, the male member taking the form of a projection;
a female coupling member provided on the second component, the female member taking the form of a groove housing the male member and forming therewith a guideway connection the direction of the guideway of which is parallel to or inscribed in the transverse plane wherein the transverse structure concerned lies.

Preferably, in said other connecting device, the groove forming the female member has, at one of its two opposite longitudinal ends in the direction of the guideway, a guideway axial abutment cooperating with one of the two opposite longitudinal ends of the projection forming the male member. In addition, on the second component, the two guideway axial abutments, respectively provided on the two guideway connections, are oriented so as to prevent the movement of the first component relative to the second component in the direction of the third component, and so as to prevent the movement of the third component relative to the second component in the direction of the first component.

Thus, in the event of dropping oriented parallel to the direction in which the three components are arranged one after the other, the two guideway axial abutments lead to placing the second component in compression between the first and third components, in order to obtain a reinforced mechanical strength of the transverse structure, and thus a better guarantee of holding its components in relation to one another.

Preferably, the transverse structure includes a ratio between its thickness, and its maximum width in the transverse plane wherein it is inscribed, less than 0.1.

Another object of the invention is a package comprising a packaging for storing and/or transporting nuclear fuel assemblies, as well as a storage device such as described above, housed in a cavity of the packaging, as well as nuclear fuel assemblies arranged in the storage device.

Other advantages and features of the invention will become apparent in the following non-limiting detailed description.

### BRIEF DESCRIPTION OF THE DRAWINGS

This description will be given with reference to the appended drawings wherein;

FIG. 1 represents a schematic sectional view of a package according to the invention, comprising in particular a storage device for storing and/or transporting nuclear fuel assemblies;

FIG. 2 represents a partial perspective view of the storage device, according to a preferred embodiment of the present invention;

FIG. 2A represents a partial perspective view of the storage device shown in the preceding figure, and wherein the transverse structure of the top is removed;

FIG. 3 is a top view of a transverse structure of the storage device shown in FIGS. 2 and 2A;

FIG. 4 is a perspective exploded view of the transverse structure of the storage device shown in the preceding figure;

FIG. 5 is a perspective view of a portion of a first component of the transverse structure shown in the preceding figure;

FIG. 6 is a perspective view of a portion of a second component of the transverse structure shown in the preceding figure;

FIG. 7 represents a perspective view of a connecting device between the first and second components, with the second component produced in line form for further clarity;

FIG. 8 represents a perspective view of a connecting device between the first and second components, with the first component produced in line form for further clarity;

FIG. 9 represents a longitudinal sectional view of the connecting device shown in FIGS. 7 and 8;

FIG. 10 represents a transverse sectional view of the connecting device shown in FIGS. 7 to 9;

FIG. 11 represents a cross-sectional view similar to that of FIG. 9, with the connecting device being shown in the form of an alternative embodiment; and

FIG. 12 represents a top view similar to that of FIG. 3, showing only one portion of the transverse structure of the storage device.

### DETAILED DESCRIPTION OF PREFERRED EMBODIMENTS

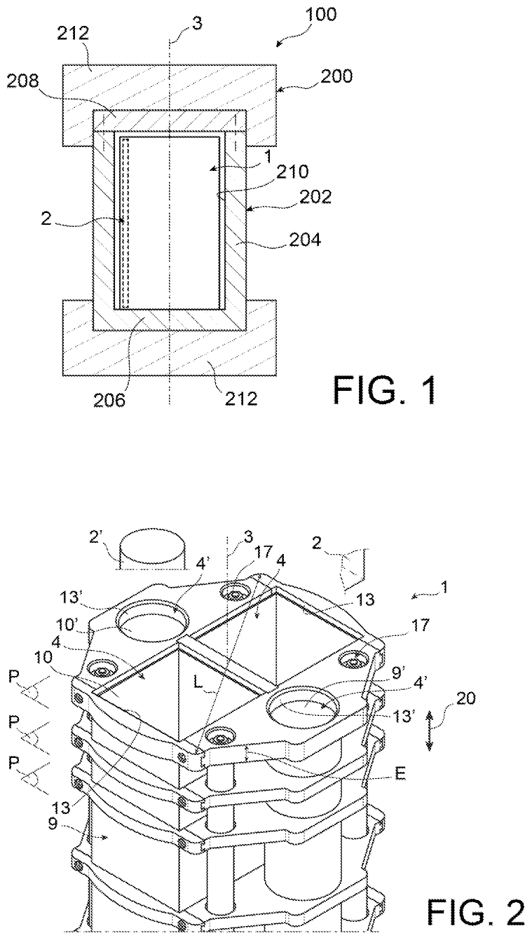

FIG. 1 represents a package 100 comprising a packaging 200 for storing and/or transporting irradiated nuclear fuel assemblies 2. The packaging 200 has a body 202 formed by a lateral body 204, a bottom 206, and a removable lid 208. The bottom 206 and the lid 208 are spaced apart from one another along the longitudinal central axis 3 of the packaging, about which the lateral body 204 extends.

The packaging 200 defines inside of its body a cavity 210, wherein a storage device 1 is housed, which will be referred to as “basket” in the following description. The basket 1 thus completes the packaging 200 to form the package 100, the latter being loaded with nuclear fuel assemblies. Indeed, as will be described in detail below, the basket 1 comprises a plurality of adjacent housings each intended to receive one of the nuclear fuel assemblies 2. When the basket 1 is housed in the cavity 210 of the packaging 200, and the nuclear fuel assemblies 2 are placed in the adjacent housings of the basket 1, the package 100 is known as “loaded”.

By way of indication, it is noted that at the axial ends of the packaging, it may have shock-absorbing covers 212, respectively covering the lid 208 and the bottom 206 of the body 202 of this packaging.

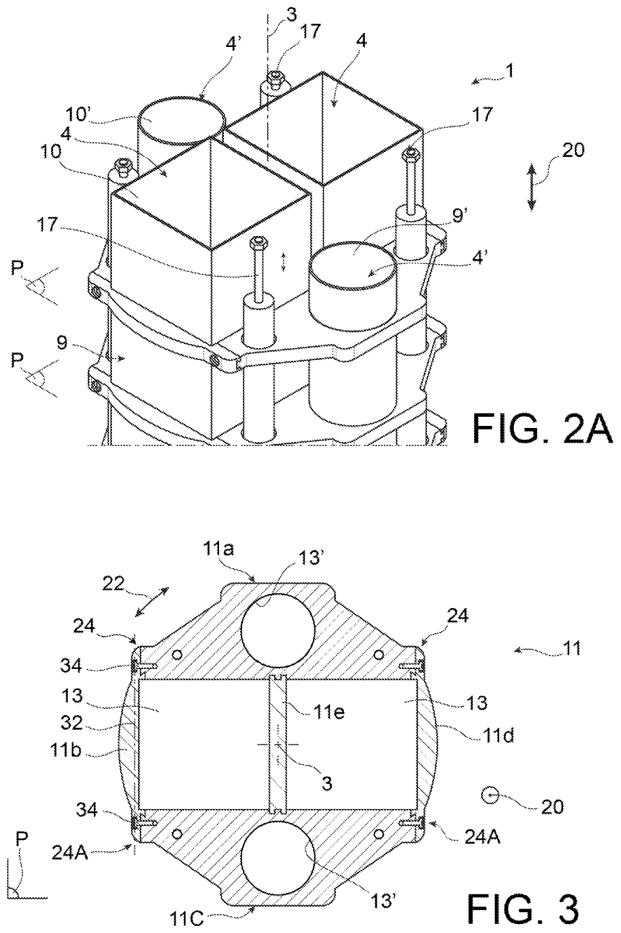

The specific feature of the invention lies in the design of the basket 1 for transporting and/or storing irradiated nuclear fuel assemblies, which will now be described with reference firstly to FIGS. 2 and 2A.

The basket 1 comprises a plurality of adjacent housings 4, 4′ disposed parallel to the axis 3, the latter also corresponding to the longitudinal central axis of the basket 1.

The number N of adjacent housings is here four, but this number could of course differ.

The two opposite housings 4 are each capable of receiving at least one fuel assembly 2 of square section, and preferably only one. As a result, they each have an inner housing-delimiting surface 10, of generally square or rectangular shaped cross-section. “Inner housing-delimiting surface 10” means the surface of the basket elements that lies directly facing the outer surface of the fuel assemblies 2.

The two opposite housings 4′ are also each capable of receiving at least one fuel assembly 2 of circular section, and preferably only one. As a result, they each have an inner housing-delimiting surface 10, of general circular shaped cross-section. Here also, “Inner housing-delimiting surface 10” means the surface of the basket elements that lies directly facing the outer surface of the fuel assemblies 2′.

The housings 4, 4′ are therefore provided so as to be juxtaposed with one another, here all around the periphery of the basket. Each housing 4, 4′ is produced by a sleeve 9, 9′ parallel to the axis 3, and preferably extending over the entire height of the basket 1 in a longitudinal direction 20 of the latter, or substantially over this entire height. Each sleeve 9, 9′ is respectively of square/rectangular or circular section. For the sleeves 9 of square or rectangular section, they may each be produced using a plurality of flat bars assembled with one another, for example four flat bars assembled by intersections. The material used for manufacturing the sleeves 9, 9′ is chosen so as to contribute to the various functions that are the mechanical function, the thermal function, and the neutron absorbing function. For example, a material such as a metal alloy comprising boron or any other neutron-absorbing element, that is to say comprising neutron absorber elements, may be retained. “Neutron absorber elements” means elements that have an effective section greater than 100 barns for the thermal neutrons. By way of indicative examples, this concerns aluminium alloys comprising boron.

In order to complete the design of the basket 1, the latter includes a plurality of transverse structures 11, spaced apart from one another in the direction 20. The transverse structures 11 are flat or substantially flat structures, each arranged in a transverse plane P of the basket 1, that is to say orthogonal to the axis 3. The transverse structures 11 are preferably identical or substantially identical, and they each have a low thickness, preferably so that a ratio between its thickness “E”, and its maximum width “L” in the transverse plane P wherein it is inscribed, is less than 0.1.

In the general shape of a disc or of a wafer, each of these structures 11 has four through-openings 13, 13′ for respectively receiving four sleeves 9, 9′. In other words, the same sleeve 9, 9′ successively passes through an opening 13, 13′ of each of the wafers 11 of the basket 1. The same applies for the assemblies 2, 2′, which successively pass through these openings 13, 13′, by being housed inside the sleeves 9, 9′. The shape of the openings 13, 13′ is also complementary to that of the sleeves that pass through them. Consequently, the through-openings 13 have a generally square or rectangular shaped section, whereas the through-openings 13′ have a generally circular shaped section.

The wafers 11 are for example made of steel or of a metal alloy, for example of aluminium alloy. But regardless of the material chosen, it is preferably free of boron or any other neutron-absorbing element within the meaning previously disclosed.

The number of wafers 11 is for example between five and twenty, even though a different number may be adopted, particularly depending on the height of the basket 1, here in the order of 4 m.

These wafers 11 are longitudinally spaced apart from one another using spacing means, here spacers 16, a plurality of which are arranged between each pair of wafers 11 directly consecutive in the stack in the direction 20. For example, three to six spacers 16 are provided at each spacing stage between the wafers 11, the spacers of the same stage preferably all having the same height in the direction 20. The spacers 16 are preferably made of steel, but other materials may be envisaged, without departing from the scope of the invention.

The structure of the basket 1 is completed by tie rods 17 that hold the wafers 11 and the spacers 16 in compression against one another, in the direction 20. The mechanical holding of the stack is thus ensured by the tie rods 17 that pass through the wafers 11, and possibly also the spacers 16, by providing a hollow design for the latter. The number of tie rods 17 may then be identical to that of the spacers 16 provided at each spacing stage of the wafers, for example four spacers/tie rods in the embodiment represented in FIGS. 2 and 2A. The tie rods 17, of known design, are preferably parallel to the axis 3, or substantially parallel to the latter.

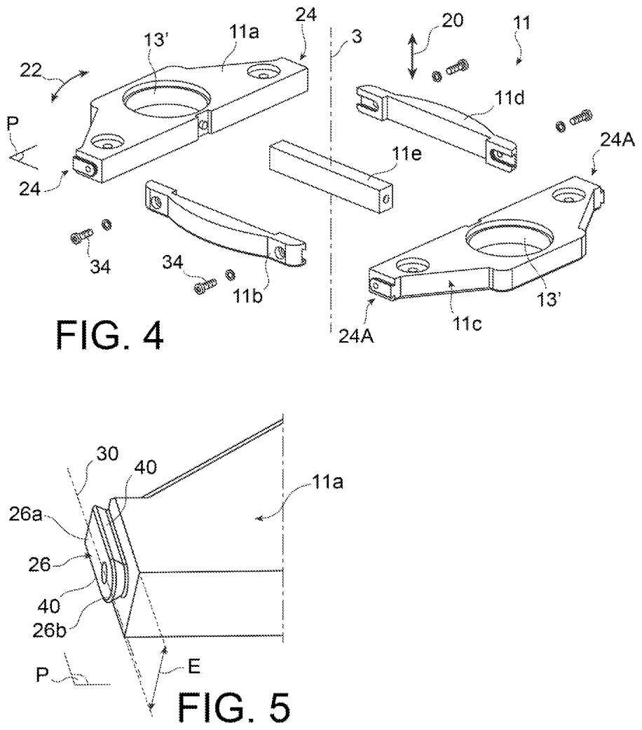

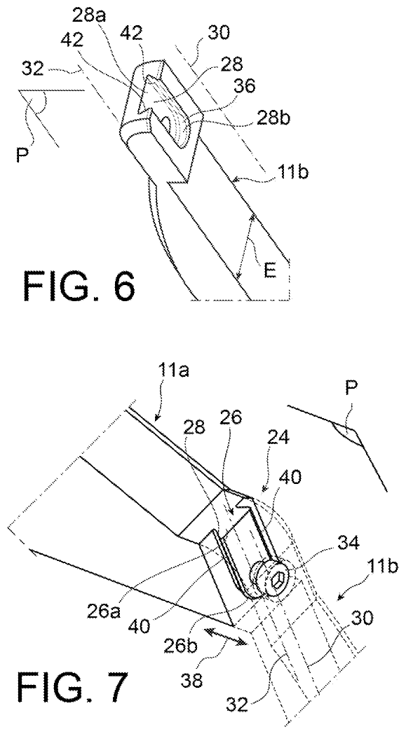

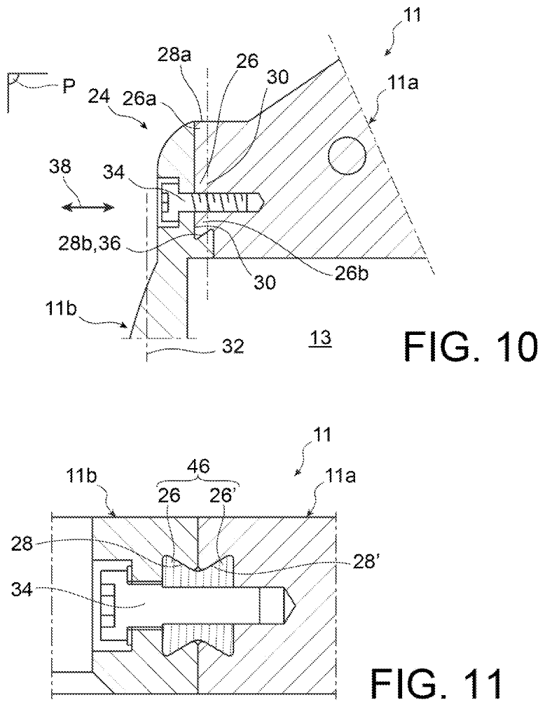

One of the specific features of the invention lies in the design of the transverse wafers 11, one of which will now be described with reference to FIGS. 3 to 10.

The wafer 11 is produced using a plurality of components attached to one another, all being inscribed in the transverse plane P associated with this wafer. In the preferred embodiment represented, four peripheral components assembled end to end are provided and are arranged one after the other therefore in a circumferential direction 22 of the basket 1.

Firstly, this concerns a first peripheral component 11a of generally trapezoidal shape, or in lunula shape, and through which one of the two openings 13′ of circular section is produced. A second peripheral component 11b in generally straight beam, or possibly lunula shape is then provided of which the domed portion is less pronounced. A third peripheral component 11c of generally trapezoidal shape is provided, identical or substantially identical to the first component 11a, by being disposed opposite and symmetrical thereto. The third peripheral component 11c is passed through by the other of the two openings 13′ of circular section. Finally, a fourth peripheral component 11d of generally straight beam, or possibly of lunula shape is provided, identical or substantially identical to the second component 11b by being disposed opposite and symmetrical thereto. Finally, a fifth central component 11e connects the first and third components 11a, 11c, by being arranged between the second and fourth components 11b, 11d, parallel thereto.

The components 11a and 11c, of larger transverse extensions, are those intended to cooperate with the tie rods and the spacers of the basket.

One of the openings 13 of square/rectangular section is delimited by a portion of the first component 11a, by the second component 11b, by a portion of the third component 11c, and by a face of the fifth component 11e. Likewise, the other opening 13 of square/rectangular section is delimited by another portion of the first component 11a, by the fourth component 11d, by another portion of the third component 11c, and by an opposite face of the fifth component 11e.

Subsequently, the attachment between the first and second components 11a, 11b, specific to the invention, will be described, and therefore the principle is preferably applied in an identical or similar way for the three other attachments between the peripheral components 11a to 11d.

Still with reference to FIGS. 3 to 10, a connecting device 24, rigid, is thus implemented between the first component 11a and the second component 11b.

The connecting device 24 firstly includes a male coupling member 26 borne by the first component 11a, by being here integral with and preferably made from a single component with this first component 11a. The male member 26 takes the form of a projection at one end of the first component 11a. The connecting device 24 also comprises a female coupling member 28 provided on the second component, this female member taking the form of a groove housing the male member 26 and forming therewith a guideway connection the direction of the guideway 30 of which is parallel to or inscribed in the transverse plane P wherein the transverse structure 11 lies. This direction of the guideway 30 is incidentally coinciding with or parallel to a longitudinal central axis 32 of the second component 11b, also inscribed in the plane P.

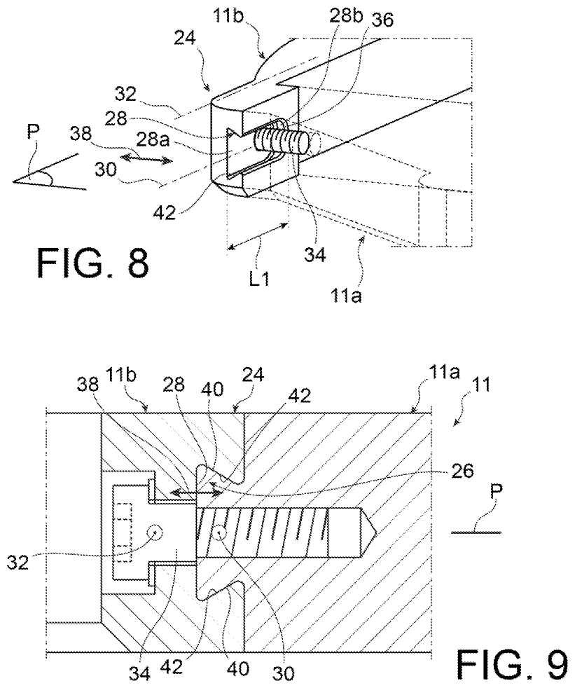

Thanks to the orientation of this guideway connection, in the plane P of the wafer 11 or parallel to this same plane, the cooperation between its male and female members 26, 28 may advantageously extend over an extended length that reinforces the mechanical strength of the wafer 11, in the event of dropping of the package. In particular, it is provided that this cooperation length L1, referenced in FIG. 8, is strictly greater than the thickness E of the components 11a, 11b, corresponding to the thickness of the wafer 11.

Preferably, the connecting device 24 includes a member for locking 34 the guideway connection, the objective of which is to hold the male member 26 relative to the female member 28 in the direction of the guideway 30. This locking member 34 thus prevents a disengagement of the two members, particularly during the assembly of the basket, but it is preferably mounted so as not to be put under any or very much strain in the event of dropping, the take up of forces is performed as a priority using members 26, 28. Preferably, the member for locking 34 the guideway connection is a screw passing through the male and female members 26, 28, by preferably being orthogonal to the direction of the guideway 30, and parallel to or inscribed in the plane P.

The groove 28 forming the female member has a first and a second opposite longitudinal end 28a, 28b in the direction of the guideway 30. The first end 28a, corresponding to that which is the outer most and the most distant from the axis 3 of the basket and of the wafer, is opened to insert the projection 26. Likewise, this projection 26 has a first and a second opposite longitudinal end 26a, 26b in the direction of the guideway 30. The insertion of this projection 26 into the groove 28 is provided by making the second end 26b penetrate into the groove before the first end 26a. On the other hand, to further reinforce the mechanical strength of the guideway connection in the event of dropping, the second end 28b of the groove 28 is sealed by a guideway axial abutment 36 cooperating with the second end 26b of the projection 26. A contact between the two, or a very small clearance is provided in the direction of the guideway 30, intended to be rapidly used in the event of dropping in order to obtain a bearing that reinforces the mechanical strength of the wafer 11.

The guideway axial abutment 36 and the associated longitudinal end 26b of the projection 26 have a complementarity of shape ensuring the holding of this longitudinal end 26b in the groove 28, in the stacking direction of the male and female coupling members 26, 28. This stacking direction, referenced 38 in FIGS. 7 to 10, is orthogonal to the direction of the guideway 30, and also orthogonal to an opening plane of the groove. The complementarity of shape ensuring the retention of the two elements 26b, 36 may be produced by a simple notch at the end 26b, so as to cooperate with a notch of complementary shape in the guideway axial abutment 36. Here again, this retention improves the mechanical strength of the wafer in the event of dropping.

Although the guideway connection may be of unilateral design in a stacking direction 38, for example with a projection 26 and a groove 28 of complementary parallelepiped shapes, this guideway connection is preferably of bilateral design in the stacking direction 38, still for the purpose of reinforcing the mechanical strength of the wafer 11. For this, the projection 26 and the groove 28 have a complementarity of shape preventing the extraction of the projection outside of the groove via the opening thereof, in the stacking direction 38. This complementarity of shape is preferably produced at the two opposite lateral sides 42 of the groove 28, which respectively cooperate with two opposite lateral sides 40 of the projection 26, so as to prevent the extraction of the projection 26.

Preferably, a notch is provided at each of the two opposite lateral sides 40 of the projection 26, this notch being identical or similar to that produced at the second end 26b of the projection 26. Thus, the projection 26 has a section, in a plane orthogonal to the direction of the guideway 30 such as the sectional plane of FIG. 9, in dovetail shape. Alternatively, other section shapes able to ensure the retention are possible, such as for example the shape of a T, or of all or part of a disc.

In this way, the second end 26b of the projection, as well as its two opposite lateral sides 40, have a continuous profile along the entire length of a U-shaped contour of the projection 26, as can be seen better in FIGS. 5, 7 and 8. By way of example, when a dovetail shape is chosen such as shown in these figures, each of the two lateral sides 40 is trimmed so as to show the acute angle required for obtaining such a dovetail shape, and this same acute angle is made at the longitudinal end 26b of the projection in order to ensure a continuity with each of the two lateral sides 40, of the same shape. To make this continuity possible, the end 26b may have connector radii, or itself be rounded such as represented in the figures. Such an embodiment with a continuous shape, which lies around the U-shaped contour of the groove formed by the lateral sides 42 and the abutment 36, facilitates the manufacturing of the two components 11a, 11b.

It is noted that although the projection 26 has been represented as integrated into the first component 11a, and the groove 28 integrated into the second component 11b, a reverse design may be envisaged, without departing from the scope of the invention. Furthermore, FIG. 11 represents an alternative embodiment wherein the projection 26, forming the male member of the guideway connection, is no longer made in one piece with the first component 11a. Indeed, this male member 26 is borne differently by the first component, since it is integrated into a distinct mechanical connector component 46 integrating another projection 26′, cooperating with a groove 28′ provided on the first component 11a. In this way, the cooperation between the projection and groove 26′, 28′ is identical or similar to the cooperation between the projection and groove 26, 28, thus forming two guideway connections of parallel directions. In this alternative, the locking screw 34 passes through the second component 11b, then the two projections 26, 26′ of the mechanical connector component 46, and is then screwed into the first component 11a.

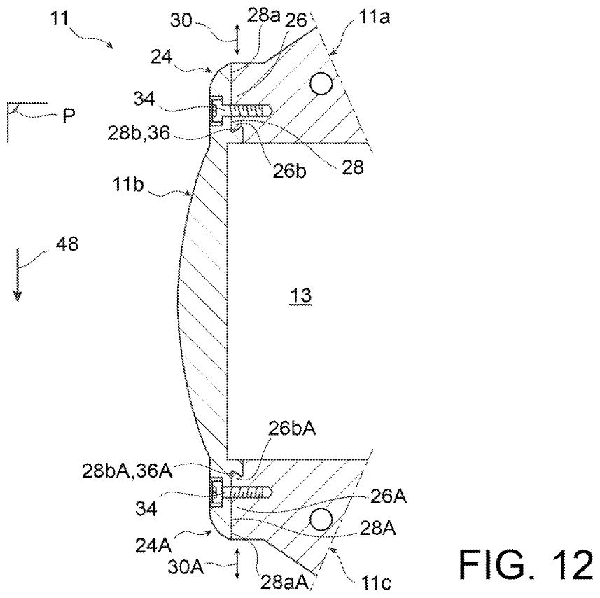

In the transverse structure 11, the second component 11b is arranged between the first and third components 11a, 11c, the third component 11c indeed being attached at an opposite end of the second component 11b using another connecting device 24A, identical or similar to the connecting device 24 between the first and second components 11a, 11b. This other connecting device 24A, which will not be described in detail due to its identity/its similarity with the device 24, is represented in FIG. 12.

Thus, this other connecting device 24A includes in particular a male coupling member 26A borne by the third component 11c, the male member taking the form of a projection, as well as a female coupling member 28A in the form of a groove provided on the second component 11b. Here also, the two members 26A, 28A form a guideway connection the direction of the guideway 30A of which is parallel to or inscribed in the transverse plane P, and also parallel to or coinciding with the direction of the guideway 30 of the other guideway connection.

In this other connecting device 24A, the groove 28A has, at one 28bA of its two opposite longitudinal ends 28aA, 28bA in the direction of the guideway 30A, a guideway axial abutment 36A cooperating with one 26bA of the two opposite longitudinal ends of the projection 26A. In addition, on the second component 11b, the two guideway axial abutments 36, 36A are oriented so as to prevent the movement of the first component 11a relative to the second component 11b in the direction of the third component 11c, and so as to prevent the movement of the third component 11c relative to the second component 11b in the direction of the first component 11a.

Consequently, in the event of dropping with the basket oriented horizontally, and with a dropping direction 48 oriented parallel to the direction in which the three components 11a, 11b, 11c are arranged one after the other (as in FIG. 12), the two guideway axial abutments 36, 36A lead to placing the second component 11b in compression between the first and third components 11a, 11c, under the opposite actions of the two projection ends 26b, 26bA. This contributes to obtaining a reinforced mechanical strength of the wafer 11, and thus a better guarantee of holding its components together in the event of dropping of the package.

Whatever the dropping direction and the orientation of the package, such as for example the axial drop, the lateral drop on normal axis, or also the lateral drop on oblique axis (for example at 45°), the connecting devices 24, 24A make it possible to benefit from an increased mechanical strength at the moment of the impact. These same connecting devices 24, 24A are moreover preferably implemented in an identical or similar way, respectively between the first and fourth components 11a, 11d, and between the third and fourth components 11c, 11d.

Of course, various modifications may be made by the person skilled in the art to the storage devices 1 that have just been described, only by way of non-limiting examples, and of which the scope is defined by the appended claims.

What is claimed is:

1. Storage device for transporting and/or storing nuclear fuel assemblies, the storage device being intended to be housed in the cavity of a packaging for transporting and/or storing nuclear fuel assemblies, and including adjacent housings, each intended to receive a nuclear fuel assembly,
the storage device comprising a plurality of transverse structures spaced apart from one another in a longitudinal direction of the storage device using spacing means, the transverse structures each being arranged in a transverse plane of the storage device, and each comprising a plurality of through-openings for passing nuclear fuel assemblies through,
wherein at least one of the transverse structures includes a first component as well as a second component attached to one another by a connecting device, the connecting device comprising:
a male coupling member borne by the first component, the male member taking the form of a projection;
a female coupling member provided on the second component, the female member taking the form of a groove housing the male member and forming therewith a guideway connection the direction of the guideway of which is parallel to or inscribed in the transverse plane wherein the transverse structure concerned lies.

2. Storage device according to claim 1, wherein the groove forming the female member has, at one of its two opposite longitudinal ends in the direction of the guideway, a guideway axial abutment cooperating with one of the two opposite longitudinal ends of the projection forming the male member.

3. Storage device according to claim 2, wherein the guideway axial abutment and the associated longitudinal end of the projection have a complementarity of shape ensuring the holding of the longitudinal end of the projection in the groove, in a stacking direction of the male and female coupling members, the stacking direction being orthogonal to the direction of the guideway as well as to an opening plane of the groove.

4. Storage device according to claim 1, wherein the guideway connection is of unilateral design in a stacking direction of the male and female coupling members, the latter preferably having parallelepiped shapes.

5. Storage device according to claim 1, wherein the guideway connection is of bilateral design in a stacking direction of the male and female coupling members, the projection and the groove having a complementarity of shape preventing the extraction of the projection outside of the groove via the opening thereof, in the stacking direction of the male and female components.

6. Device according to claim 5, wherein the projection has two opposite lateral sides having a complementarity of shape with two opposite lateral sides of the groove with which they respectively cooperate, so as to prevent the extraction of the projection outside of the groove via the opening thereof, in the stacking direction of the male and female members.

7. Device according to claim 6, wherein the projection has a section, in a plane orthogonal to the direction of the guideway, in the shape of a dovetail, of a T, or of all or part of a disc.

8. Device according to claim 6, wherein the guideway axial abutment and the associated longitudinal end of the projection have a complementarity of shape ensuring the holding of the longitudinal end of the projection in the groove, in a stacking direction of the male and female coupling members, the stacking direction being orthogonal to the direction of the guideway as well as to an opening plane of the groove, and wherein said longitudinal end of the projection, as well as its two opposite lateral sides, have a continuous profile along the entire length of a U-shaped contour of the projection.

9. Storage device according to claim 1, further comprising a member for locking the guideway connection, holding the male member relative to the female member in the direction of the guideway, the member for locking the guideway connection preferably being a screw passing through the male and female members.

10. Storage device according to claim 1, wherein the first and second components are two peripheral components of the transverse structure, and, preferably, partly delimiting at least one of the through-openings of this transverse structure.

11. Storage device according to claim 1, wherein the first or the second component has a generally straight beam shape, of which the longitudinal central axis of the beam is parallel to or coinciding with the direction of the guideway.

12. Storage device according to claim 1, wherein said transverse structure includes a third component arranged so that the second component is located between the first and third components that it connects using another connecting device, this other connecting device comprising:
a male coupling member borne by the third component, the male member taking the form of a projection;
a female coupling member provided on the second component, the female member taking the form of a groove housing the male member and forming therewith a guideway connection the direction of the guideway of which is parallel to or inscribed in the transverse plane wherein the transverse structure concerned lies.

13. Storage device according to claim 12, wherein in said other connecting device, the groove forming the female member has, at one of its two opposite longitudinal ends in the direction of the guideway, a guideway axial abutment cooperating with one of the two opposite longitudinal ends of the projection forming the male member, and wherein on the second component, the two guideway axial abutments, respectively provided on the two guideway connections, are oriented so as to prevent the movement of the first component relative to the second component in the direction of the third component, and so as to prevent the movement of the third component relative to the second component in the direction of the first component.

14. Storage device according to claim 1, wherein the transverse structure includes a ratio between its thickness, and its maximum width in the transverse plane wherein it is inscribed, less than 0.1.

15. Package comprising a packaging for storing and/or transporting nuclear fuel assemblies, as well as a storage device according to claim 1, housed in a cavity of the packaging, as well as nuclear fuel assemblies arranged in the storage device.
